(19) United States
(12) Patent Application Publication
(10) Pub. No.: US 2014/0038543 A1
(43) Pub. Date: Feb. 6, 2014

(54) PERSONAL SECURITY SYSTEM FOR A MOBILE DEVICE

(71) Applicants: Thomas W. Rissman, Wilmette, IL (US); Anuraag Bhargava, Naperville, IL (US)

(72) Inventors: Thomas W. Rissman, Wilmette, IL (US); Anuraag Bhargava, Naperville, IL (US)

(21) Appl. No.: 13/960,052

(22) Filed: Aug. 6, 2013

Related U.S. Application Data
(60) Provisional application No. 61/679,996, filed on Aug. 6, 2012.

(51) Int. Cl. H04W 4/22

(52) U.S. Cl. CPC H04W 4/22
USPC 455/404.2

(57) ABSTRACT

The present application is directed to a system and method for providing a personal security system for a mobile device. More particularly, the present application is directed to a system and a method for providing effective and reliable tracking of a user's location to a monitoring office via a mobile device.

### CROSS-REFERENCE TO RELATED APPLICATIONS

This application claims benefit under 35 U.S.C. §119(e) of U.S. Provisional Patent Application Ser. No. 61/679,996, entitled “PERSONAL SECURITY SYSTEM FOR A MOBILE DEVICE”, filed Aug. 6, 2012, naming Thomas W. Rissman and Anuraag Bhargava as the inventors, the complete disclosure being incorporated herein by reference.

### TECHNICAL FIELD

The present application relates generally to a personal security system provided for a mobile device. More specifically, the present application is directed to a personal safety monitoring system for use in personal handheld wireless mobile devices on cellular and data networks, namely, for communicating with a monitoring center.

### BACKGROUND

Mobile devices, including smart phones, are well known. Smart phones operate in the same way as traditional phones, but include additional processing capabilities. For example, smart phones are generally equipped with a touch screen, camera, global positioning system, navigation functionality, and keyboard. Examples of smart phones include and, for example, are branded by the trademarks iPhone®, Android®, Windows® and Blackberry®.

Recently the operating systems of such smart phones have allowed users to create program applications that provide specific functionality to the smart phone. It is an object of the present application to provide a reliable personal security system for a mobile device. Specifically, the present patent application is directed to a method and system for providing a reliable personal security system to a user via a program application for a mobile device. Moreover, the present application provides a reliable location positioning service to track a user's location in real time.

Additionally, it is further an object of the present application to provide a personal security system wherein the program application identifies the quality of the location positioning data supplied to the monitoring service.

### SUMMARY

The present application is directed to a system and method for providing a personal security system for a mobile device. More particularly, the present application is directed to a system and a method for providing effective and reliable tracking of a user's location to a monitoring office via a mobile device.

### BRIEF DESCRIPTION OF THE DRAWINGS

FIG. 1 is a system drawing of the present personal security service.

FIG. 2 is a detailed system drawing of the personal security service of FIG. 1a.

FIG. 3 is a detailed system drawing of the personal security service of FIG. 1a.

FIG. 4a depicts an embodiment of a data message.

FIG. 4b depicts another embodiment of a data message.

FIG. 4c depicts yet another embodiment of a data message.

FIG. 5 is a screenshot of a user interface associated with a back office for monitoring a mobile device in accordance with an embodiment of the present invention.

FIG. 6 is a screenshot of another user interface associated with a back office for monitoring a mobile device in accordance with another embodiment of the present invention.

### DETAILED DESCRIPTION OF THE DRAWINGS

The present application is directed to a system and method for providing a personal security system for a mobile device. More particularly, the present application is directed to a system and a method for providing effective and reliable tracking of a user's location to a monitoring office via a mobile device.

The present personal security system provides a service for providing personalized safety monitoring, advice and support. Specifically provided is a subscription service that allows those individuals in potential emergency situations to access an operator who tracks and monitor's the user's location and provides customized information. As described above, the program application may be activated by at least one activation button.

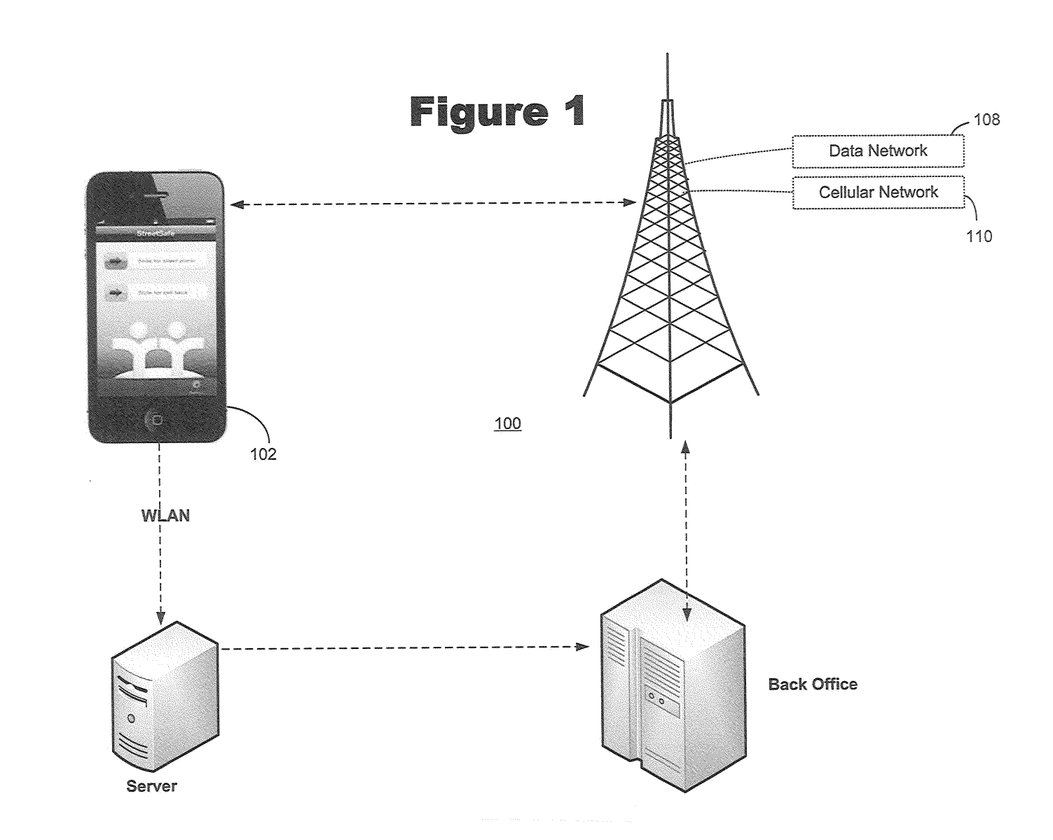

As further illustrated in FIG. 1, the present personal security system 100 is generally comprised a software client for a program application, which is integrated into a mobile device 102, wherein the mobile device communicates with a monitoring back office via a cellular network 110 and/or a data network.

In one embodiment, the mobile device includes a plurality of activation buttons. Preferably, the program application provides two separate buttons via the graphic user interface of the mobile device 102, as illustrated in FIG. 1. For example, where the graphic user interface is in the form of touch screen, separate slider buttons may be provided, such that the user can activate either alarm by sliding his or her finger across the screen on top of the respective button.

In one example, a user may activate a distress alarm (“Red Alarm” or “Silent Alarm”) to signify an immediate danger and required immediate assistance. If the “Red Alarm” or “Silent Alarm” is triggered, certain user information and location position data is immediately and continually transmitted from the mobile device 102 to the back office. The continual transmission of location position data to the back office provides for “real-time” tracking of location position data which may be visually depicted on a user interface associated with the back office. Accordingly, the back office may serve as a monitoring office. Through continual monitoring of the transmitted information, the back office may provide an appropriate safety response, such as notifying a Public Safety Answering Point, police department, 911 center, or the like.

In another example, a user may activate a distress alarm (“Green Alarm” or “Non-Emergency Alarm”) to signify a non-emergency situation. If the “Green Alarm” or “Non-Emergency Alarm” is triggered, certain user information and location position data is immediately and continually transmitted from the mobile device 102 to the back office. Accordingly, the back office may serve as a monitoring office. The continual transmission of location position data to the back office provides for “real-time” tracking of location position data which may be visually depicted on a user interface associated with the back office. Through continual monitoring of the transmitted information, the back office may provide an appropriate safety response. For example, a safety advisor monitoring the transmitted information from the mobile device 102 may call the user and provide the user with appropriate safety response instructions. In one example, if the user requires directions or feels unsafe in the user's surroundings, the safety advisor may provide safety advice based on the user's stated situation along with the location information transmitted by the mobile device.

In another embodiment, the mobile device may be adapted to allow the user to deactivate the distress alarm. For example, the mobile device may be adapted to allow the user to enter a code, pin number, or the like within a predetermined time period to deactivate the distress alarm.

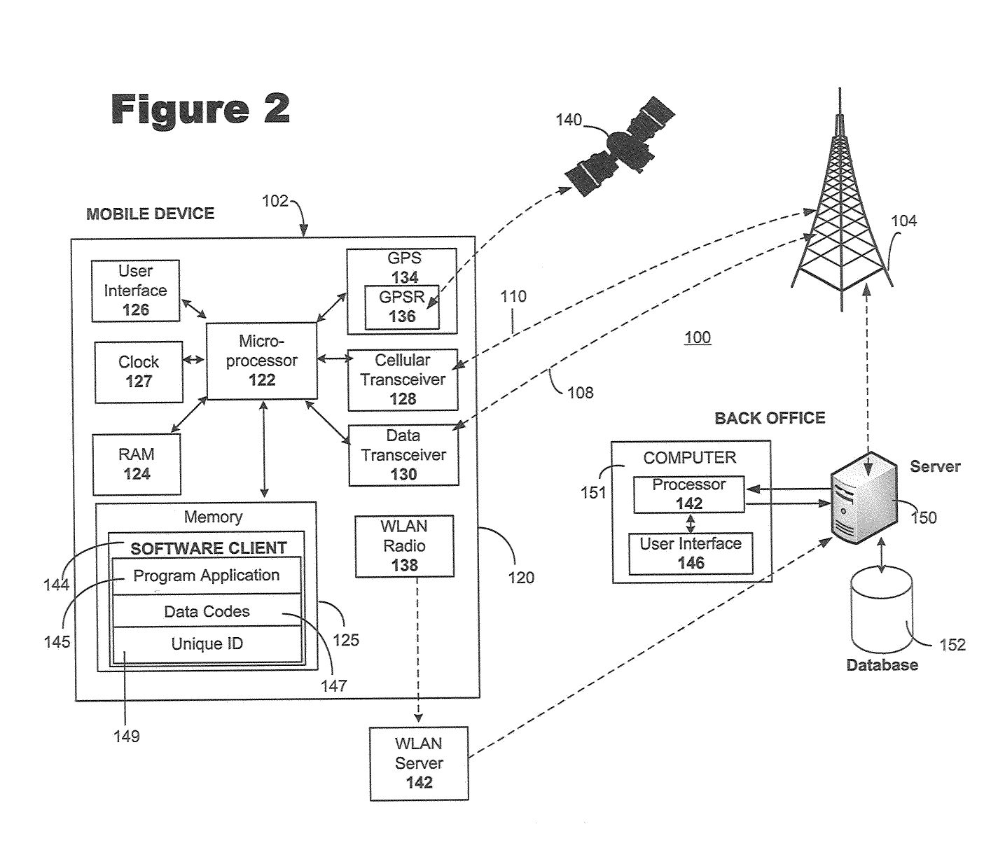

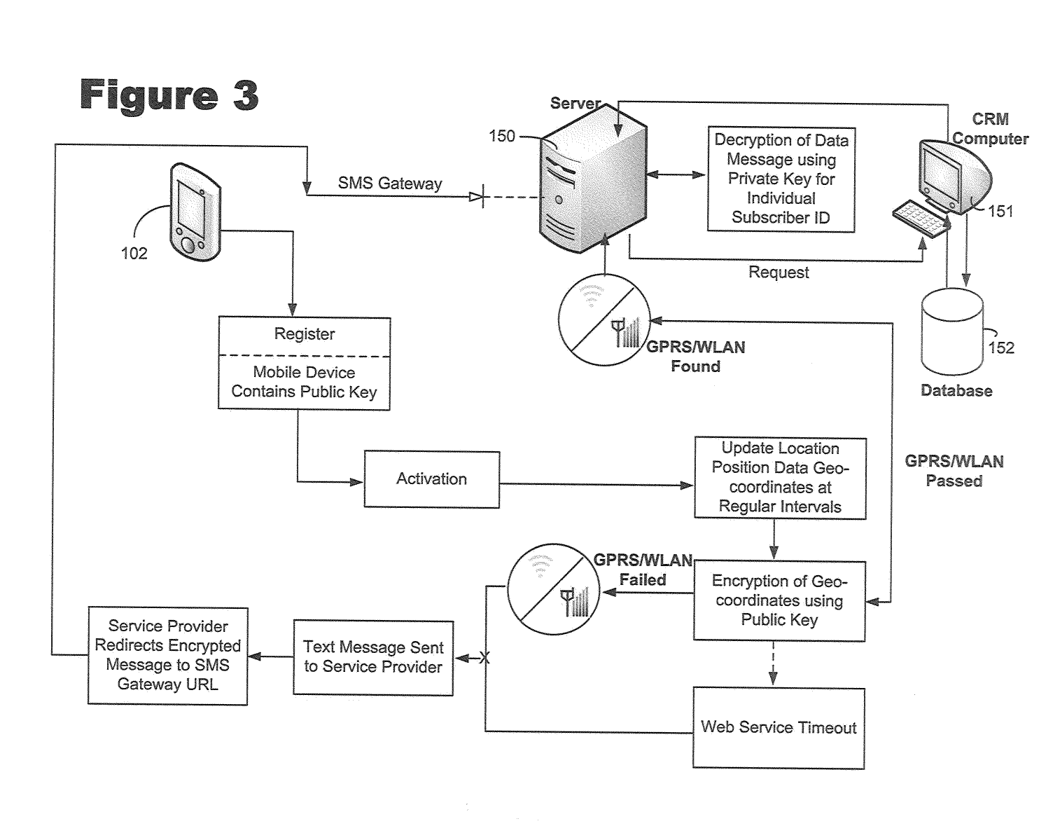

FIGS. 2 and 3 illustrate one embodiment of the personal security system components and method as described above. Generally, the mobile device includes voice communication, data communication, and computer processing functionality. For example, the mobile device may be in the form of a smart phone, such as those branded by the trademarks iPhone®, Android®, Windows® and Blackberry®, or electronic tablet, such as those branded by the trademarks iPad®, Android®, Windows® and Blackberry®. Specifically, in one embodiment, the mobile device 102 includes a microprocessor 122. The microprocessor 122 is integrally coupled to a user interface 126, which allows a user to input data, view information, and otherwise interact with the device 102. For example, the user interface 126 may be comprised of a graphical user interface having a touch-screen or physical buttons for inputting user data. The microprocessor 122 is further coupled to a clock 127, random access memory (RAM) 124 and a memory location 125, each of which are discussed in further detail below.

The mobile device 102 also includes at least one location radio for determining the geographical location of the mobile device. Specifically, the mobile device 102 includes a global positioning system (UPS) radio 134, which is integrally coupled to the microprocessor 122 and includes a GPS receiver (GPSR) 136 for receiving satellite 140 transmitted location data. Additionally, the mobile device 102 includes a location network radio, which may be employed to determine mobile device location via a network-based localization system, such as triangulation of radio towers. Generally, network-based localization techniques utilize the service provider's network infrastructure to identify the location of the mobile device.

The mobile device 102 further includes at least one network radio, or transceiver, for transmitting and receiving data. For example, in one embodiment, the mobile device 102 includes a WLAN (e.g., Wi-Fi) radio 138, a cellular data network wireless transceiver 130 (e.g., GPRS), and a cellular network wireless transceiver 128 (e.g., text message, SMS message, MMS message or the like). The WLAN (e.g., Wi-Fi) radio 138 is wirelessly connected to a server 142, which connects to a local data transmission network. The cellular data network wireless transceiver 130 (e.g., GPRS) is in wireless communication with a cell tower 104. The cellular network wireless transceiver 128 is also in wireless communication with a cell tower 104 (e.g., text message, SMS message, MMS message or the like). Through one of more of these networks, the mobile device transmits data to a monitoring back office 106.

FIGS. 2 and 3 illustrate one embodiment of the personal security system components and method. In order to provide a secure means of identifying and communicating data between the mobile device and the back office, a user is a subscriber of the personal security system's services. To become a subscriber, each user may establish an account with the back office using a user name and password. Each account may be linked to and identified by, a subscriber identification code (“Subscriber ID”), having a unique public key and a private key which are stored in the back office database 152. The account may also be associated with certain user information and data, including a user's description (e.g. gender, race, age, weight, height, hair color, eye color, medical conditions and blood type, etc.), contact information, or the like. The Subscriber ID, unique public key, private key and/or any of this account information may further be similarly and concurrently stored in the mobile device so as to provide a means of identifying data transmitted between the mobile device and back office.

During operation of the personal security system, the user may initiate the program application 145 stored in the memory location 125 of the mobile device 102 via the user interface. In response thereto, the microprocessor 122 runs the processes written in the program application 145. One of the processes may include display of at least one activation button on the user interface for activation of a distress signal. Upon activation of a distress signal by a user via the user interface as described above, the microprocessor 122 signals the GPS 134 to receive location position data at select intervals of time to maintain effective tracking of user location. This location position data may be stored in either the random access memory (RAM) location 124 or the memory location 125. Preferably, the personal security system acquires location of the mobile device 102 using the mobile device's GPS 134. However, if GPS is unavailable (i.e., due to satellite obstruction), the microprocessor 122 is adapted to retrieve location position data through an alternative position method. For example, an alternative position method may be multilateration of radio signals between radio towers of the network and the mobile device, as described above.

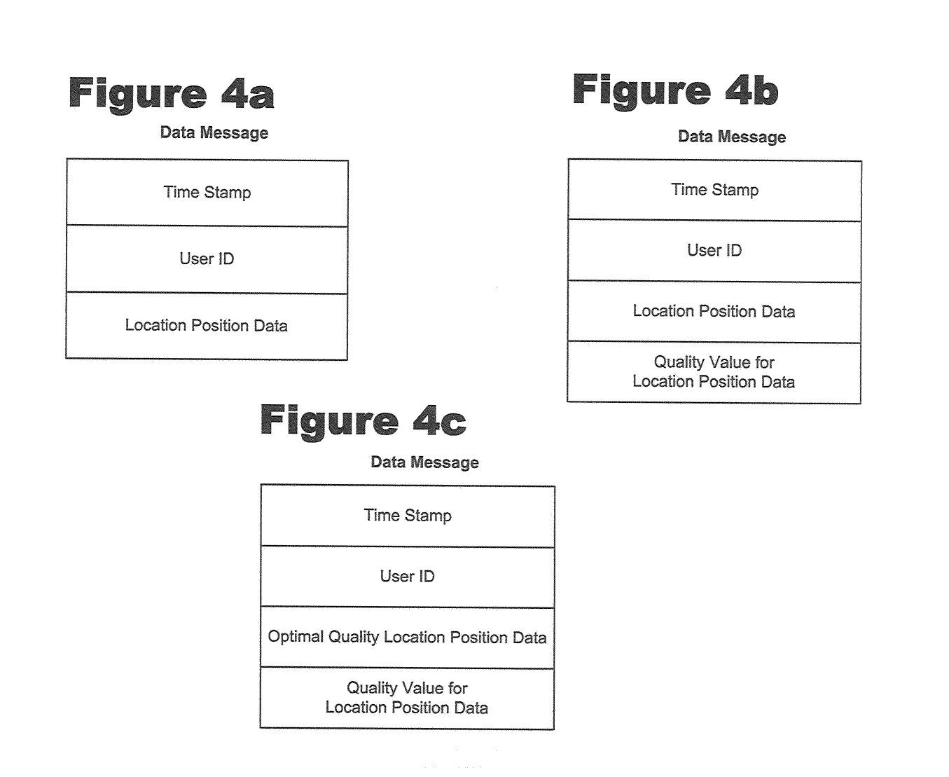

This location position data is transmitted to the back office at select intervals of time via any one of the WLAN (e.g., Wi-Fi) radio 138, a cellular data network wireless transceiver (e.g, GPRS) 130, or a cellular network wireless transceiver (e.g., text message, SMS message, MMS message or the like) 128. More particularly, the microprocessor 122 packages the mobile device identifier (e.g., Subscriber ID or other account information), location position data, and a time stamp into an encrypted data message as shown in FIG. 4a. Examples of the encrypted data message are further described below and shown in FIGS. 4b and 4c.

The microprocessor 122 first attempts to send the encrypted data message to the back office server via a WLAN (e.g., Wi-Fi) radio 138 (if available) or a cellular data network wireless transceiver (e.g, GPRS) 128. If the request is successful, the back office server 150 responds with a message that the encrypted data message was received. If the request is unsuccessful, no response message is received or a message is sent back to the mobile device the back office server is not responding. Once received, back office server decrypts the encrypted data message and identifies the mobile device using the corresponding mobile device identifier (e.g., Subscriber ID) stored in the database 152. The back office server then generates a new unique case ID and the location position data for the particular mobile device are stored at the back office server 150. The mobile device's location position data is transmitted to the CRM computer 151 such that an operator may monitor and track the mobile device's location position data.

However, if the mobile device does not receive a receipt notification from the server 150 within a proscribed time period (e.g., fifteen seconds), the above data network is deemed unavailable, or failed. Accordingly, the microprocessor 122 is adapted to alternatively generate a text message, SMS message, MMS message or the like, containing the encrypted data message. Because SMS messages are sent through the cellular telephone network, even if there is no data network (e.g., WLAN) or cellular data service (e.g., GPRS) available, the text message, SMS message, MMS message or the like may be sent so long as there is phone (cellular) service. The encrypted message is sent from the mobile device 102 via the cellular network (e.g., text message, SMS message, MMS message or the like) 110 to the cellular network service provider (not shown). The service provider then directs the text message, SMS message, MMS message or the like to the back office server 150 for decryption thereof. Once received, back office server decrypts the encrypted data message and identifies the mobile device using the corresponding mobile device identifier (e.g., Subscriber ID) stored in the database 152. The back office server then generates a new unique case ID and the location position data for the particular mobile device are stored at the back office server 150. The mobile device's location position data is transmitted to the CRM computer 151 such that an operator may monitor and track the mobile device's location position data.

During the next transmission interval, the microprocessor 122 will once again attempt to send the encrypted data message to the back office server via a WLAN (e.g., Wi-Fi) radio 138 (if available) or a cellular data network wireless transceiver (e.g, GPRS) 128. If that fails, the microprocessor 122 is again adapted to alternatively generate a text message, SMS message, MMS message or the like, containing the encrypted data message.

Accordingly, the personal security system continually uses all of the WLAN (e.g., Wi-Fi) radio 138, cellular data network wireless transceiver 130 (e.g., GPRS), and cellular network wireless transceiver 128 (e.g., text message, SMS message, MMS message or the like) to provide a reliable and fail-safe system to ensure that real-time location position data is continuously transmitted to the back office. Accordingly, because location position data is communicated in a continual fail-safe manner, and sent within frequent intervals, the present application provides a reliable personal security system.

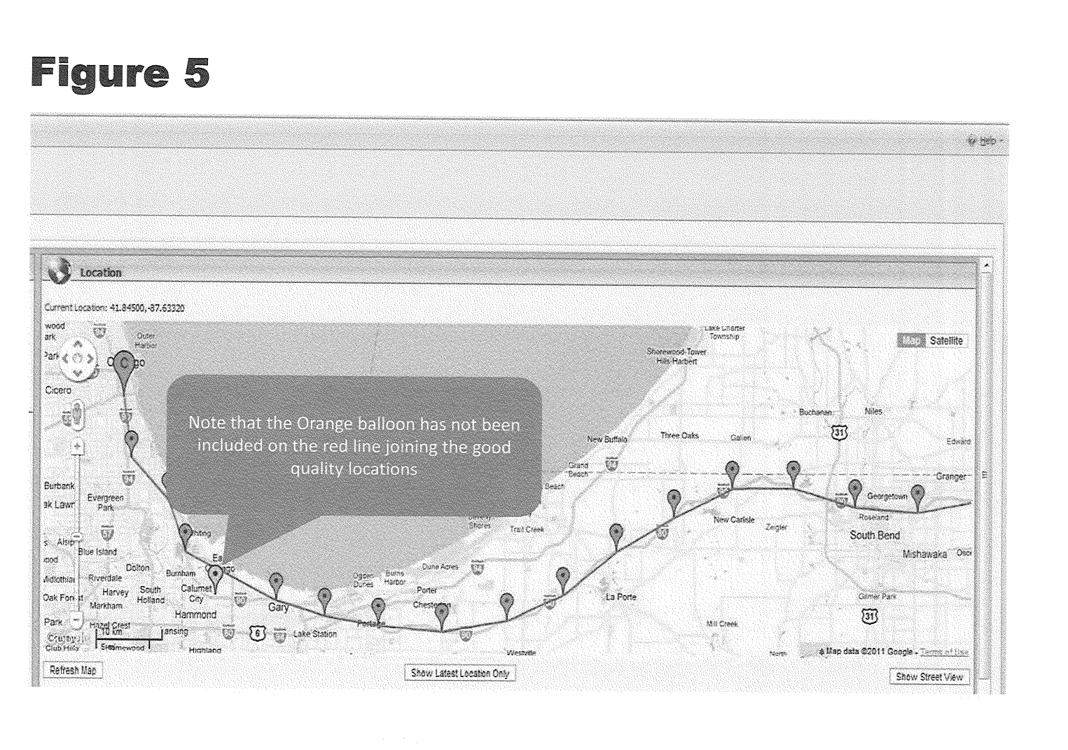

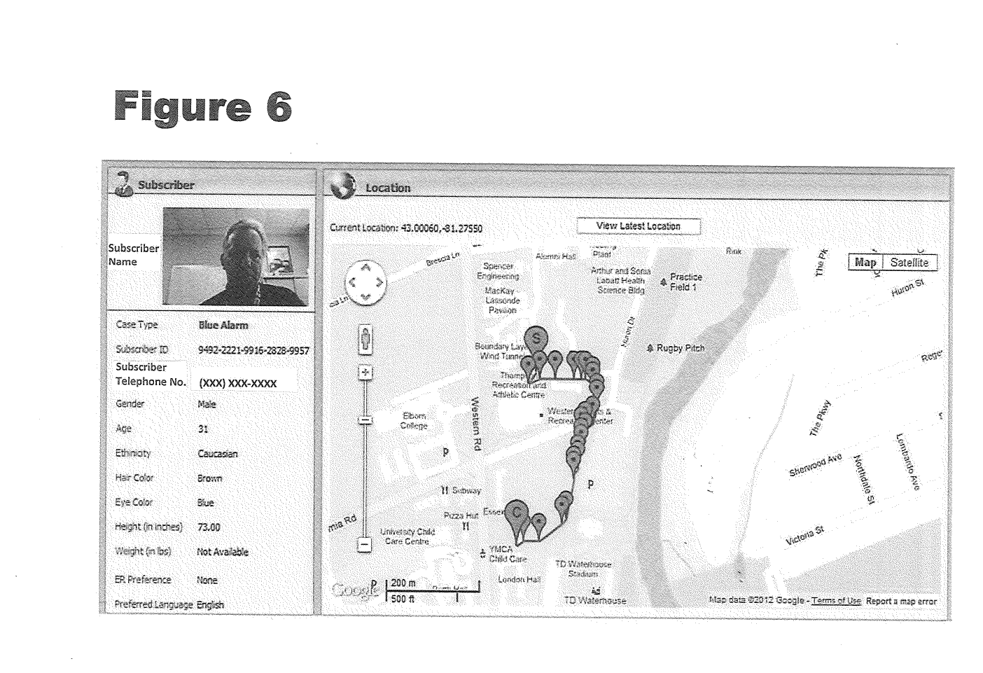

The continual transmission of location position data whether through the data network, cellular data network or cellular network to the back office provides for “real-time” tracking of location position data which may be visually depicted on a user interface associated with the back office as shown in FIGS. 5 and 6. Through continual monitoring of the transmitted information, the back office may provide an appropriate safety response, such as notifying a Public Safety Answering Point, police department, 911 center, or the like. Accordingly, the individual monitoring the mobile device through the back office may further provide information to the Public Safety Answering Point, police department, 911 center, or the like with information associated with the mobile device, such mobile device/user real-time location, the user's description (e.g. gender, race, age, weight, height, hair color, eye color, medical conditions and blood type, etc.), contact information, or the like.

In one embodiment, which preserves battery life of the mobile device, the encrypted data message is sent at select intervals. For example, once the distress signal has been activated by a user, for the first 10 minutes thereafter, the microprocessor 122 may be adapted to retrieve location position data of the mobile device, and send the encrypted data message to the back office every 15 seconds. After this 10 minute interval has expired, the frequency that location position data is acquired or the transmission of encrypted data message may be decreased (e.g., to every 30 seconds for the next 20 minutes), After 30 minutes and thereafter, the frequency that location position data is acquired or the transmission of encrypted data message may further be decreased.

It is further an object of the present application to provide a personal security system that identifies the quality of the location data. Specifically, the mobile device may be adapted to determine the quality of location position data when acquiring location position data. In turn, the mobile device may be adapted to designate a quality value to the location position data. For example, the quality value may be based on a scale of 1 to 5, wherein 5 is the best possible score. The higher the score, the more accurate the location position data.

The mobile device may be adapted to package the quality value of the location position data in the encrypted data message to be sent to the back office server, for example as illustrated in FIG. 4b. After the encrypted data message is received, the back office server decrypts the encrypted data message and identifies the mobile device using the corresponding mobile device identifier (e.g., Subscriber ID) stored in the database 152. The back office server then generates a new unique case ID and the location position data for the particular mobile device are stored at the back office server 150. The mobile device's location position data is transmitted to the CRM computer 151 such that an operator may monitor and track the mobile device's location position data in view of the quality values of such data. Specifically, visual indicators on the CRM computer interface may be associated with the each quality value. In one example, color-coded markings may be associated with each of the quality values 1-5 and shown on the CRM computer interface. As a result, the operator at the CRM computer may view and interpret the quality of the location position data being supplied by the mobile device. The CRM computer may further be adapted to provide a view of only location position data which has higher quality values, as illustrated in FIG. 6.

It is yet another object of the present application to provide a personal security system for a mobile device using only higher quality location position data. Specifically, once a distress signal is activated, the mobile device may be adapted to select and transmit to the back office only higher quality location position data recorded during a specific interval of time. In one example, the mobile device microprocessor may be adapted to sort location position data stored during a select interval of time based on the quality value ascribed thereto. Once the data is sorted, the mobile device only packages the most accurate (i.e., highest quality) location position data into the encrypted data message as illustrated in FIG. 4c.

Additionally, the encrypted data message includes a time stamp indicating the time the encrypted message was sent from the mobile device. This time is determined by the mobile device clock. When the encrypted data messages are received and decrypted by the back office server, the server sorts the data messages in order of time stamp (i.e., when message was sent). Thus, even if an encrypted data message sent first in time via the cellular network (i.e., SMS message) is received by the server after an encrypted data message sent later in time via the data network (i.e., via GPRS), the server sorts the SMS message as an earlier data message. As a result, the data transmitted to the CRM computer for the operator to interpret depicts an accurate representation of the user's current location and prior movement.

The present application has been described in accordance with the embodiments shown, and one of ordinary skill in the art will readily recognize that there could be variations to the embodiments, and any variations would be within the spirit and scope of the present application. Accordingly, many modifications may be made by one of ordinary skill in the art without departing from the spirit and scope of the appended claims.

1. A mobile device having a personal security system adapted to communicate location position data to a back office server, said mobile device comprising:
a microprocessor,
at least one location radio coupled to the microprocessor for determining the location position data,
at least one data network transceiver coupled to the microprocessor for transmitting and receiving location position data through a data network, and
at least one cellular network transceiver coupled to the microprocessor for transmitting and receiving location position data through a cellular network,
wherein the microprocessor is adapted to transmit location position data to the back office server through the data network transceiver, and wherein the microprocessor is adapted to transmit location position data to the back office server through the cellular network in the event that a network connection between the data network transceiver and the back office server is unavailable.

2. The mobile device of claim 1, wherein the data network transceiver is a WLAN network transceiver.

3. The mobile device of claim 2, wherein the WLAN data network transceiver is a WIFI network transceiver.

4. The mobile device of claim 1, wherein the cellular network transceiver is an SMS cellular network transceiver.

5. The mobile device of claim 1, wherein the cellular network transceiver is an MMS cellular network transceiver

6. A mobile device having a personal security system adapted to communicate location position data to a back office server, said mobile device comprising:
a microprocessor,
at least one location radio coupled to the microprocessor for determining the location position data, and
a network transceiver coupled to the microprocessor for transmitting and receiving location position data,
wherein the microprocessor is adapted to determine quality of the location position data and transmit the location position data and quality of such location position data to the back office server through the network transceiver such that the location position data may be monitored in view of the quality values of such location position data.

7. The mobile device of claim 6, wherein the location radio is adapted to determine location position data for a select period of time, and wherein the microprocessor is further adapted to determine quality of each location position data during the select period of time, and wherein the microprocessor is further adapted to transmit the location position data having the highest quality during the select period of time to the back office server through the network transceiver such that highest quality location position data may be monitored.

8. A method for communicating location position data from a mobile device having a personal security system to a back office server comprising the steps of:
determining the location position data of the mobile device using at least one location radio coupled thereto,
determining the quality of the location position data, and
transmitting the location position data and quality of such location position data from the mobile device to the back office server such that the location data may be monitored in view of the quality values of such location position data.

9. The method for communicating location position data from a mobile device having a personal security system to a back office server of claim 8, further comprising the steps of:
determining the location position data for a select period of time,
determining the quality of each location position data during the select period of time, and
transmitting the location position data having the highest quality during the select period of time to the back office server through the network transceiver such that highest quality location position data may be monitored.

10. The method for communicating location position data from a mobile device having a personal security system to a back office server of claim 8, further comprising the step of:
visually depicting the location position data and quality of each location position data on a map such that a user monitoring such visual depiction may ascertain a more accurate location of the mobile device.
